(19) United States
(12) Patent Application Publication
(10) Pub. No.: US 2005/0116821 A1
(43) Pub. Date: Jun. 2, 2005

(54) Optical asset tracking system

(75) Inventors: Philip A. Wilsey, Cincinnati, OH (US); Fred R. Beyette JR., Cincinnati, OH (US); Darryl S. Dieckman, Cincinnati, OH (US); Dale E. Martin, Cincinnati, OH (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: Clifton Labs, Inc., Cincinnati, OH (US)

(21) Appl. No.: 10/725,250

(22) Filed: Dec. 1, 2003

(51) Int. Cl. G08B 1/08

(52) U.S. Cl. 340/539.13; 340/572.1; 340/5.92; 235/375; 235/491; 235/454; 382/103

(57) ABSTRACT

Described are a system and a method for optical tracking of assets. The system includes a sensor having a plurality of pixels. Each pixel is adapted to produce an electrical signal responsive to an incident optical data signal emitted by an optical tag attached to an asset. The system also includes a sensor processor in communication with the sensor and configured to generate an electrical data signal based on optical data signals incident on the pixels. The sensor processor also generates asset data in response to the electrical data signals from the pixels. The sensor and sensor processor can be implemented as an optical communications imager in which each pixel generates a communication data signal based on incident light. Alternatively, the sensor can include a digital video camera or an analog video camera for lower bandwidth communications.

### FIELD OF THE INVENTION

The invention relates generally to asset tracking. More particularly, the invention relates to a system and method for tracking assets based on an optical communications imager and optical tags attached to each asset to be tracked.

### BACKGROUND

The location and status of assets can be determined using different means of asset tracking. For example, equipment, inventory and personnel can be tracked so that their position and status can be determined at different times. One common type of asset tracking is based on barcodes attached to the assets. The barcodes are examined with a barcode reader or scanner. Another type of asset tracking is based on passive radio frequency identification (RFID) tags attached to the assets. The RFID tags are read using a radio frequency (RF) interrogation device. According to either type of asset tracking, assets are tracked as they pass by checkpoints equipped with the appropriate readers. Checkpoints are frequently installed at shipping and receiving locations, and at entry and exit locations such as doorways. Such passive systems can determine where an asset is at discrete times but not where the asset is at any moment.

More recently, real-time locating systems (RTLSs) have been developed that use a network of sensors to determine the location and status of an asset in real-time. An RTLS has many advantages, including reducing inventory and improving employee productivity because items and personnel can be located quickly. Other benefits include a reduction in the time spent locating equipment for maintenance, upgrade or inventory review; a reduction or elimination of items that are lost, stolen or hoarded; and a security benefit realized by allowing or prohibiting tagged items or personnel entry into or exit from controlled areas. Current RF based RTLSs require that an RF transmitter be attached to each asset to be tracked. Multiple receivers are used to listen for any transmitters that are within reception range and record the transmitted data. Using this information, the identity of an asset is determined and the position of the asset is established by triangulation. A software based system can be used to track the asset as it changes location.

RF based RTLSs have inherent disadvantages. Electromagnetic interference (EMI) generated by equipment such as welders, electric motors and other machinery can hinder tracking capability. Conversely, EMI generated by RF communications of an RTLS can interfere with sensitive equipment such as computer controlled machinery and health care equipment. In addition, because RTLSs typically operate in unlicensed frequency bands, various wireless communications that increasingly clutter these frequency bands can interfere with RTLS operations. Furthermore, RTLS communications generate RF signals which can penetrate unshielded buildings and enclosures. Thus security is at risk because valuable information such as inventory levels can be ascertained by outside observers monitoring the RF signals.

What is needed is an asset tracking system that can monitor the location of an asset any time. The asset tracking system should be immune to EMI generated in electrically noisy environments. In addition, the asset tracking system should not be susceptible to eavesdropping. The present invention satisfies these needs and provides additional advantages.

### SUMMARY OF THE INVENTION

In one aspect the invention features an optical asset tracking system including a sensor having a plurality of pixels and a sensor processor in communication with the sensor. Each pixel is configured to generate an electrical signal in response to an optical data signal emitted by an optical tag and incident on the pixel. The sensor processor is configured to generate an electrical data signal representative of the optical data signal incident on each pixel. The sensor processor generates asset data responsive to the electrical data signal for each pixel.

In one embodiment each pixel is configured to provide a communications data signal in response to the optical data signal emitted by the optical tag and incident on the pixel. In another embodiment the sensor and the sensor processor includes an optical communication imager. In another embodiment the sensor includes an analog video camera in communication with a frame grabber. In still another embodiment the sensor includes a digital video camera. In yet another embodiment the optical asset tracking system also includes an optical tag database in communication with the sensor processor. The optical tag database stores asset data for each of a plurality of optical tags. In another embodiment the optical asset tracking system also includes a tracking processor in communication with the sensor processor.

In another aspect the invention features a method for real-time location of an asset having an optical tag. The method includes emitting an optical data signal from the optical tag and detecting, at a sensor having a plurality of pixels, the optical data signal at one or more of the pixels. The optical data signal includes asset data. The method also includes determining the asset data in response to the detected optical signal. In one embodiment the method also includes determining the location of the asset in response to a determination of which one or more pixels detected the optical data signal. In another embodiment the method also includes detecting an interrogation signal at the optical tag and performing the step of emitting the optical data signal in response to the detection of the interrogation signal.

In another aspect the invention features an optical asset tracking system including a plurality of sensor processors each in communication with a respective one of a plurality of sensors. Each of the sensors has a plurality of pixels with each pixel configured to generate an electrical signal in response to an optical data signal emitted by an optical tag and incident on the pixel. Each sensor processor is configured to provide asset data in response to the communications data from the respective sensor. In one embodiment the optical asset tracking system also includes a tracking processor in communication with the sensor processor through a communications network. In a further embodiment the optical asset tracking system also includes an optical tag database in communication with the tracking processor. The optical tag database stores asset data for each of a plurality of optical tags. In another embodiment the optical asset tracking system also includes a plurality of tracking processors each in communication with a respective one of the sensor processors.

In another aspect the invention features an optical tag for generating an optical data signal including asset data. The optical tag includes an optical modulator, a memory module for storing asset data, and a tag processor in electrical communication with the optical modulator and the memory module. The tag processor generates a data signal in response to the asset data and the optical modulator generates an optical data signal in response to the data signal. In one embodiment the optical tag also includes an environmental sensor in electrical communication with the tag processor. In another embodiment the optical tag also includes a control circuit in electrical communication with the tag processor and the optical modulator. The control circuit provides a control signal in response to the data signal. In a further embodiment the optical tag also includes a trigger sensor to detect an interrogation signal. The trigger sensor is in communication with the tag processor and the control signal is responsive to the detection of the interrogation signal at the trigger sensor.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is a block diagram illustration of an embodiment of an optical asset tracking system in accordance with the invention.

FIG. 2 is a functional block diagram of the sensor and sensor processor of FIG. 1.

FIG. 3 is a functional block diagram of a sensor and a sensor processor according to another embodiment of an optical asset tracking system in accordance with the invention.

FIG. 4 is a block diagram of another embodiment of an optical asset tracking system in accordance with the invention.

FIG. 5 illustrates an optical communications imager used to monitor assets in a room in accordance with an embodiment of the invention.

FIG. 6 is a block diagram of an embodiment of an optical tag constructed in accordance with the invention.

FIG. 7 is a schematic diagram of an embodiment of an optical tag constructed in accordance with the invention.

### DETAILED DESCRIPTION

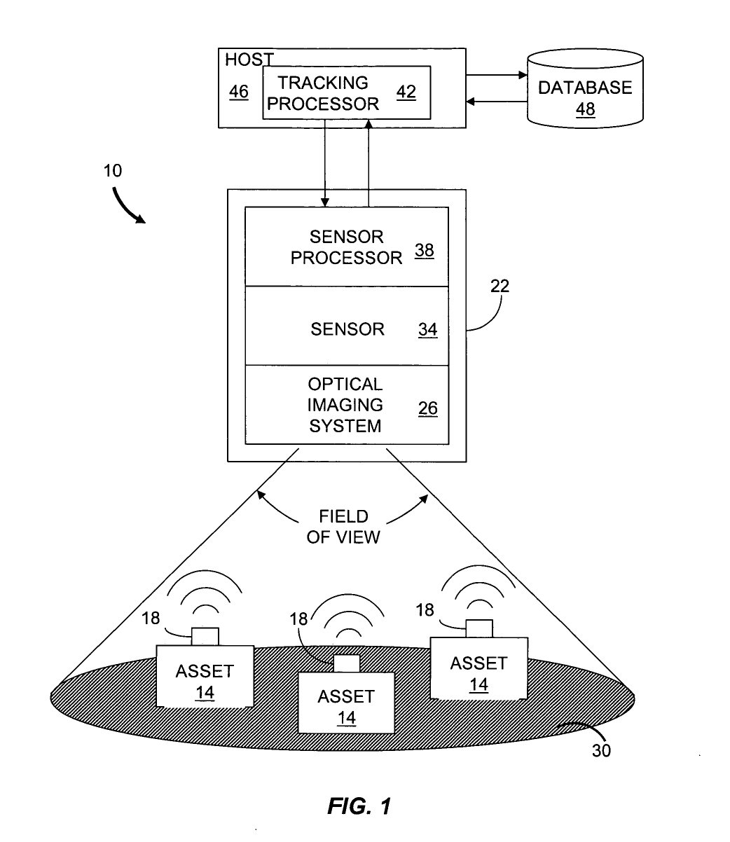

FIG. 1 is a block diagram illustrating an embodiment of an optical asset tracking system 10 according to the present invention. Affixed to each asset 14 is an optical tag 18 that includes an optical modulator, such as an optical source (e.g., light emitting diode (LED) or laser) or a modulated reflector. The optical modulator transmits asset data by way of an optical signal to an optical communications imager 22. The optical communications imager 22 includes an optical imaging system 26 to generate an image of a monitored area 30, or tracking region, on a sensor 34 having an array of pixels. Each pixel includes circuitry to receive high-speed optical communications data and to contribute data for generation of a video signal. The optical communications imager 22 also includes a sensor processor 38 for extracting the data in one or more optical signals incident on the array of pixels. Thus the optical asset tracking system can track a significant number of assets 14 within its field of view. The above implementation of an optical communications imager is described in U.S. patent application Ser. No. 10/306,555, filed Nov. 27, 2002, titled “Optical Communications Imager” and U.S. patent application Ser. No. 10/305,626, filed Nov. 27, 2002, titled “Optical Communications Imager,” which are incorporated by reference herein in their entirety.

A tracking processor 42 embedded in a host computer 46 communicates with the sensor processor 38 to receive the pixel data. The host computer 46 can be local to the optical communications imager 22 or it can be at a remote location, such as a different room or building. The tracking processor 42 determines the asset data and asset location information for each asset 14 in the field of view of the optical communications imager 22, and generates asset tracking information. The sensor processor 38 and the tracking processor 42 can be implemented in any device or circuitry used to process data to achieve the desired functionality. In one embodiment the sensor processor 38 and the tracking processor 42 are integrated as a single processor providing both sensor and tracking functionality. In other embodiments the sensor processor 38 and the tracking processor 42 are implemented as dedicated electronic circuits.

A tag tracking database 48 keeps track of the current location and status of each tag used in the optical asset tracking system 10. Asset locations recorded in the tracking database 48 can be retrieved to determine where the asset 14 was located at various times. Environmental conditions and aging information can be recorded so that any assets 14 having limited usefulness based on environmental exposure or age can be located and used before similar assets 14 having a longer lifetime. The tracking database 48 can be queried to quickly determine the location of an asset 14 having infrequent utilization. In one embodiment asset data stored in the tag tracking database 48 is referenced to corresponding video data generated by the optical communication imager. For example, an individual tampering with an asset 14 can be viewed on video with corresponding asset data overlaid on the video display.

In other embodiments of the optical asset tracking system 10, the tracking functionality is integrated with the optical communications imager 22. For example, asset identification can be performed by a processor co-located with the optical communications imager 22. Additionally, an integrated alarm can be activated in response to assets 14 being moved within or removed from the monitored area 30.

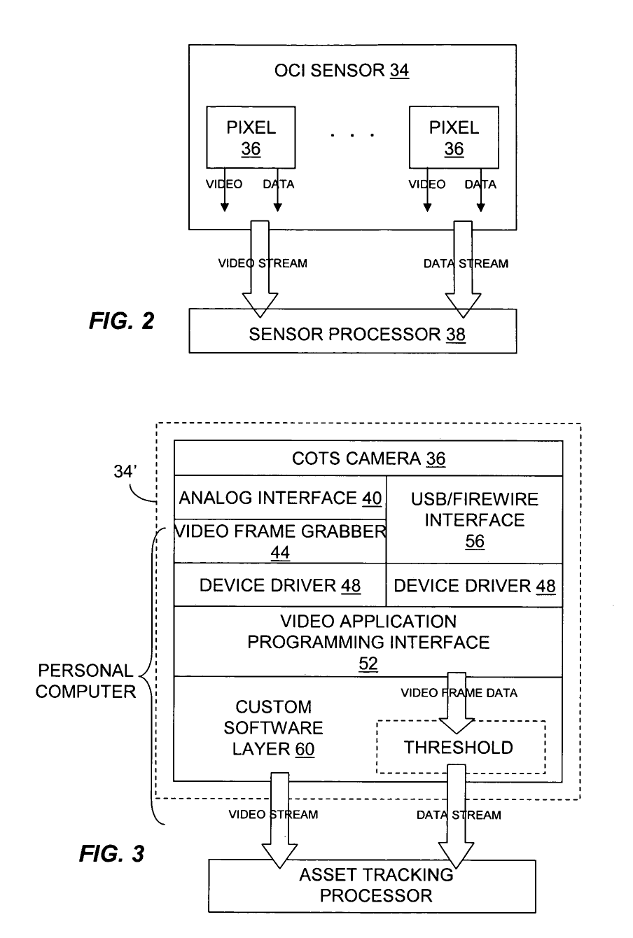

FIG. 2 illustrates the functionality of various components of the optical communications imager 22 depicted in FIG. 1. Each pixel 36 in the sensor 34 generates a video signal and communications data. The video signals from the pixels 36 are multiplexed into a video data stream and provided to the sensor processor 38. Similarly, the communications data from the pixels 36 are multiplexed into a communications data stream and provided to the sensor processor 38. Asset tracking functionality is implemented in the sensor processor 38, or may be implemented with an additional processing module.

FIG. 3 illustrates a portion of an embodiment of an optical asset tracking system in which commercially-available components replace the sensor 34 and sensor processor 38 of the optical communications imager 22 of FIG. 1. The sensor 34′ includes a commercial off the shelf (COTS) video camera 36 for generating an analog or digital video signal. If an analog video camera is employed, an analog interface 40, video frame grabber 44 and device driver 48 are used to generate digital data, i.e., video frame data, which can be manipulated with a video application programming interface 52, such as Video for Windows or Video4Linux. Alternatively, if a digital video camera is used, a digital interface 56 employing, for example, the USB (Universal Serial Bus) or Firewire standard, and a device driver 48 are used to provide the video frame data to the video application programming interface 52. An additional software component 60 separates the video frame data into a video stream and a data stream similar to the video and data streams of the sensor 34 of FIGS. 1 and 2. The data stream is determined, for example, by comparing the intensity value from each pixel to a threshold value to determine whether an optical bit is present during the video frame. Subsequent processing of the video and data streams for asset tracking is similar.

An important difference between the sensor 34 for the optical communications imager 22 and the sensor 34′ fabricated from commercially-available components is that the communications data rate of the latter is limited to the frame rate of the camera 36. More specifically, the camera 36 does not provide communications data in the conventional sense; however, a single pixel can support communications for data rates that do not exceed the frame rate. Thus the communications data rate is less by orders of magnitude. In applications where data transfer between assets 14 and the sensor 34 are low, the asset tracking system 10′ constructed from commercial components is preferred based on its substantially lower cost.

Advantageously, the optical asset tracking system 10 of the invention is not affected by electromagnetic interference (EMI) sources, such as electric motors and machinery, because optical signals are utilized. Furthermore, the data transmitted from the optical tags 18 is not vulnerable to eavesdropping by parties outside the room or building in which the assets 14 are located.

The asset data and tracking information generated by the optical asset tracking system 10 can be shared with other resources such as enterprise management tools and planning systems, and the asset tracking data can be used for a wide range of purposes. By way of example, assets 14 that can be tracked include factory equipment, vehicles, valuable items, employees, hospital patients and the like. Employees can be tracked by attaching an optical tag to a badge worn on the employee's clothing. Room lights, electrical power, automatic doors, safety equipment, security equipment and utilities can be activated or deactivated according to the location of the employee. Similarly, optical tags can be attached to hospital patients using wrist bands, badges and the like. Alternatively, an optical tag can be integrated into a bandage that can be affixed directly to the skin. The optical tag can record the health status, health history and medical treatment history of the patients. Items having critical time and environmental sensitivity, such as human organs and blood, can be tracked. For example, a human organ can be tracked from its point of harvest to its point of insertion. Environmental sensors can be attached to the organ carrier to record environmental parameters during transport. The recorded data can be broadcast during transport to confirm that the organ is not exposed to unsatisfactory conditions.

Optical broadcast of the recorded information may be continuous or can be initiated in response to an interrogation signal received by the optical tag. Alternatively, periodic or continuous broadcast of general patient information can occur with detailed patient information being broadcast in response to the interrogation signal. In one example, the optical tag includes one or more sensors to monitor a physical parameter associated with the health of the patient. If it is determined that a physical parameter crosses an associated threshold value, the optical tag automatically initiates a broadcast of patient information to the optical communications imager 22. In another example, devices having critical maintenance schedules or usage limitations can be tracked. For example, a blood distribution unit can be interrogated to determine its use history and current delivery rate.

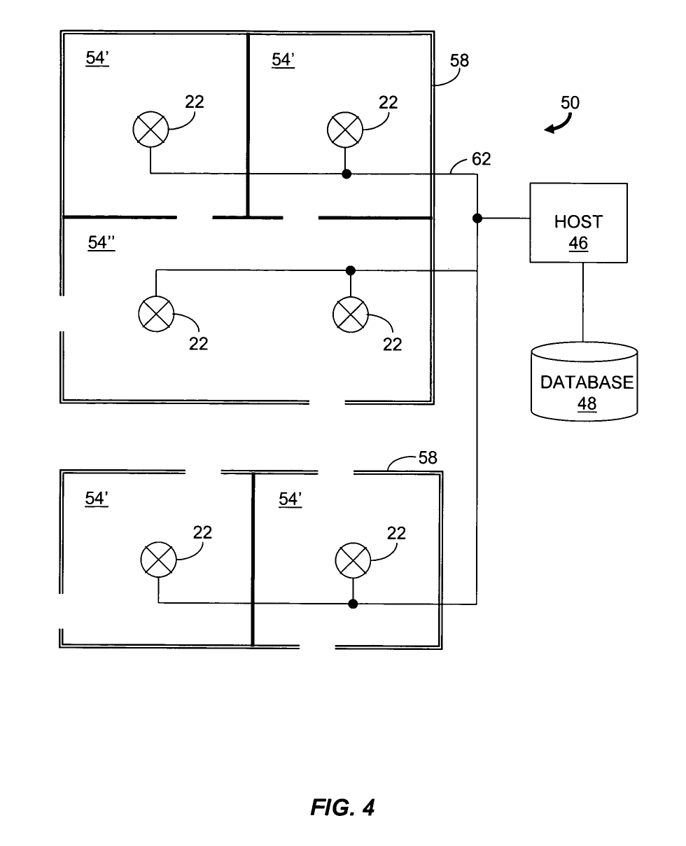

FIG. 4 illustrates an embodiment of an optical asset tracking system 50 according to the invention in which multiple optical communication imagers 22 are deployed in multiple rooms 54′, 54″ (generally 54) of separate buildings 58. The buildings 58 can be located in an office park or campus environment. Alternatively, the buildings can be geographically separated by a few miles or by thousands of miles. Although only two buildings 58 are illustrated, it should be recognized that the principles of the invention apply to optical asset tracking systems having optical communications images installed in any number of buildings.

Each optical communications imager 22 observes a monitored area 30 (see FIG. 1) that potentially includes one or more assets 14 to be tracked. The monitored area 30 preferably includes all of the floor space of a room 54, however, depending on the type of assets 14 to be tracked, only a portion of a room 54′ may be included in the monitored area 30. In the illustrated embodiment, two optical communications imagers 22 are used to monitor a single large room 54″. The fields of view of the two optical communications imagers 22 in the large room 54″ can be distinct. Conversely, the fields of view can overlap if a gap between the corresponding monitored areas 30 is unacceptable. The optical communication imagers 22 in the optical asset tracking system 50 are coupled via a network 62, such as a wired Ethernet, RF, infrared (IR) or optical fiber based network, to a host computer 46, such as a personal computer (PC), in communication with a tag tracking database 48.

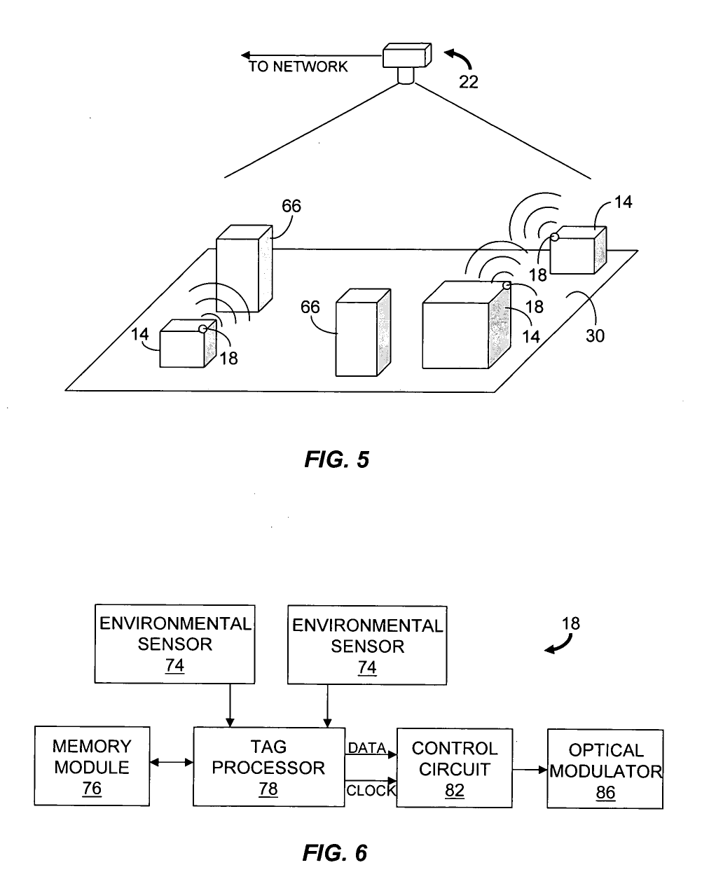

FIG. 5 depicts the optical communications imager 22 used to monitor assets 14 in a room 54′. An optical tag 18 is attached to each asset 14 to be tracked in a location that permits the optical signal to propagate unobstructed to the optical communications imager 22. For example, it is preferable to mount an optical tag 18 to the top of the asset 14 if the line of sight between the asset 14 and the optical communications imager 22 might otherwise be blocked by the asset 14 or other assets 14 and structures 66 in the room.

Optical tags 18 can take on a variety of forms. For example, an optical tag 18 can include an optical source that includes an LED or a laser that emits an optical signal at regular intervals. If it is important to constantly monitor the location of the assets 14, the optical source continuously emits the optical signal. In one embodiment the optical tag 18 includes a tag processor, a memory module and one or more sensors to monitor environmental parameters (e.g., temperature and g-forces). The memory module stores the data generated by the sensor. Broadcasts of optical data can include raw sensor data and processed sensor data, such as the minimum, maximum and average of one or more of the parameter values determined after the previous broadcast. In another embodiment the memory is provided by the asset 14. The data stored in the asset memory is provided to the optical tag 18 through an interface module (e.g., RS/232, I2C, USB, Ethernet or Firewire) on the asset 14. Thus the optical tag 18 serves as a communication relay between the asset 14 and the host system 46 and database 48.

Broadcasts of asset data can be periodic or continuous, as described above, or broadcasts can be initiated on-demand. Periodic and on-demand broadcasting are preferred over continuous broadcasting in many applications to improve battery life. In an example of on-demand broadcasting, asset data is transmitted by manually activating a switch or button on the optical tag 18. Alternatively, the optical tag 18 includes an RF sensor, optical detector or acoustic sensor to receive an RF interrogation signal, optical interrogation signal or acoustical interrogation signal, respectively. In one embodiment the interrogation signal includes security data which is examined by the optical tag 18 to ensure the validity of the interrogation request. The optical tag 18 initiates a broadcast upon detection of the interrogation signal. In another embodiment broadcasting is triggered when an environmental condition is changed or crosses a predetermined threshold value. For example, broadcasting can be initiated when movement of the asset is detected, when the ambient temperature increases (or decreases) to a predetermined temperature or when acoustic noise exceeds a predetermined level.

Asset data broadcasts can be automatically initiated. For example, if a tag processor determines that one of the monitored environmental parameters exceeds a threshold value, an immediate broadcast of the asset data is initiated. In another example, a motion detector integrated with the optical tag 18 initiates broadcasting if the asset 14 moves.

The information content broadcast by the optical tag 18 can vary. For example, an optical tag 18 can broadcast a limited data set at one broadcast interval and a larger data set at a longer broadcast interval. In another example, the optical tag 18 broadcasts limited data at regular intervals and detailed data for on-demand broadcasts or when a monitored parameter crosses a threshold.

FIG. 6 is a functional block diagram of one embodiment of an optical tag 18 constructed according to the invention. The optical tag 18 includes any number of environmental sensors 74 in communication with a tag processor 78. A memory module 76 provides for temporary storage of raw data and processed data for possible broadcast. The memory module 76 can also store unique identification data associated with the asset to which it is attached. The tag processor 78 receives and processes the environmental data, and sends the processed data, a clock signal, and the identification data to a control circuit 82. In response, the control circuit 82 generates a control signal for generating the optical data signal at an optical modulator 86. In one embodiment the optical modulator 86 is an optical source. In an alternative embodiment the optical modulator 86 is a modulated reflector which modulates an incident optical signal or ambient light in response to the asset data to be transmitted. The environmental sensors 74 can include temperature sensors, optical detectors, pressure sensors, and any device that can detect an environmental parameter and generate a corresponding electrical signal.

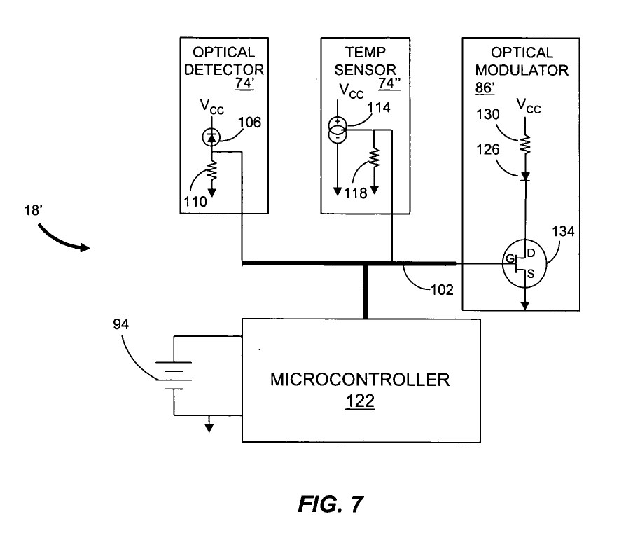

FIG. 7 is a detailed illustration of an embodiment of an optical tag 18′ constructed in accordance with the present invention. A battery 94 supplies power for various components of the tag 18′. Environmental sensors 74 include an optical detector 74′ and a temperature sensor 74″ which communicate with a microcontroller 98 via a data bus 102. The optical detector 74′ includes a photodiode 106 and resistive component 110 that produce an output current proportional to incident light and the temperature sensor 74″ includes a transducer 114 and resistive component 118 that produce an output current proportional to temperature. In the illustrated embodiment the tag processor 78 is a microcontroller 122 (e.g., 8-bit CMOS microcontroller model no. PIC12C67X manufactured by Microchip Technology Inc.) having multiple analog-to-digital (A/D) channels and embedded data memory. A clock signal generated by the microcontroller 122 is used to trigger broadcasts of asset data at predetermined intervals. The optical modulator 86 includes an LED 126 in series with a resistive component 130. The LED 126 has an output power and wavelength selected according to the spectral sensitivity of the optical communications imager sensor 34 and the geometry of the monitored area 30. To generate the optical signal, the LED current is modulated by a control signal applied to the gate of an N-channel field effect transistor (FET) 134.

In an alternative embodiment the LED 126, resistive component 130 and FET 134 shown in FIG. 7 are replaced with a modulated reflector and control circuit. An incident optical beam is intensity modulated according to the asset data to be transmitted to the optical communications imager 22. In another embodiment the incident optical beam is an optical interrogation signal.

While the invention has been shown and described with reference to specific preferred embodiments, it should be understood by those skilled in the art that various changes in form and detail may be made therein without departing from the spirit and scope of the invention as defined by the following claims.

1. An optical asset tracking system comprising:
a sensor having a plurality of pixels, each pixel configured to generate an electrical signal in response to an optical data signal emitted by an optical tag and incident on the pixel; and
a sensor processor in communication with the sensor, the sensor processor configured to generate an electrical data signal representative of the optical data signal incident on each pixel, the sensor processor generating asset data responsive to the electrical data signal for each pixel.

2. The optical asset tracking system of claim 1 wherein each pixel is configured to provide a communications data signal in response to the optical data signal emitted by the optical tag and incident on the pixel.

3. The optical asset tracking system of claim 2 wherein the sensor and the sensor processor comprise an optical communications imager.

4. The optical asset tracking system of claim 1 wherein the sensor comprises a digital video camera.

5. The optical asset tracking system of claim 1 wherein the sensor comprises an analog video camera in electrical communication with a frame grabber.

6. The optical asset tracking system of claim 1 further comprising an optical tag database in communication with the sensor processor, the optical tag database storing asset data for each of a plurality of optical tags.

7. The optical asset tracking system of claim 1 further comprising a tracking processor in communication with the sensor processor.

8. The optical asset tracking system of claim 7 wherein the sensor processor and the tracking processor are integrated as a single processor.

9. The optical asset tracking system of claim 7 wherein the tracking processor comprises a host computer.

10. The optical asset tracking system of claim 1 wherein asset data comprise at least one of asset identification data, environmental data, medical data and status data.

11. The optical asset tracking system of claim 1 further comprising the plurality of optical tags, each of the optical tags configured for attachment to an asset.

12. A method for real-time location of an asset having an optical tag, the method comprising:
emitting an optical data signal from the optical tag, the optical data signal including asset data;
detecting, at a sensor comprising a plurality of pixels, the optical data signal at one or more of the pixels; and
determining the asset data in response to the detected optical data signal.

13. The method of claim 12 further comprising determining the location of the asset in response to a determination of which one or more pixels detected the optical data signal.

14. The method of claim 12 further comprising detecting an interrogation signal at the optical tag and performing the step of emitting the optical data signal in response thereto.

15. The method of claim 12 further comprising:
determining a value of an environmental parameter;
comparing the value of the environmental parameter to a threshold value; and
performing the step of emitting the optical data signal in response to the comparison.

16. The method of claim 12 further comprising generating sensor data and wherein the asset data comprises the sensor data.

17. The method of claim 12 further comprising generating processed sensor data.

18. The method of claim 12 wherein the asset data comprises at least one of asset identification data, environmental data, medical data and status data.

19. An optical asset tracking system comprising:
a plurality of sensors each having a plurality of pixels, each pixel configured to generate an electrical signal in response to an optical data signal emitted by an optical tag and incident on the pixel; and
a plurality of sensor processors each in communication with a respective one of the sensors, each sensor processor configured to provide asset data in response to the communications data from the respective sensor.

20. The optical asset tracking system of claim 19 further comprising a tracking processor in communication with the sensor processors through a communications network.

21. The optical asset tracking system of claim 19 further comprising a plurality of tracking processors, each of the tracking processors being in communication with a respective one of the sensor processors.

22. The optical asset tracking system of claim 20 further comprising an optical tag database in communication with the tracking processor, the optical tag database storing asset data for each of a plurality of optical tags.

23. The optical asset tracking system of claim 20 wherein the tracking processor comprises a host computer.

24. The optical asset tracking system of claim 19 wherein asset data comprise at least one of asset identification data, environmental data, medical data and status data.

25. The optical asset tracking system of claim 19 further comprising the plurality of optical tags, each of the optical tags configured for attachment to an asset.

26. An optical tag for generating an optical data signal having asset data, comprising:
an optical modulator;
a memory module storing asset data; and
a tag processor in electrical communication with the optical modulator and the memory module, the tag processor generating a data signal responsive to the asset data, the optical modulator generating an optical data signal in response to the data signal.

27. The optical tag of claim 26 wherein the optical modulator comprises a light emitting diode.

28. The optical tag of claim 26 wherein the optical modulator comprises a laser.

29. The optical tag of claim 26 wherein the optical modulator comprises a modulated reflector.

30. The optical tag of claim 26 further comprising an environmental sensor in electrical communication with the tag processor.

31. The optical tag of claim 26 further comprising a control circuit in electrical communication with the tag processor and the optical modulator, the control circuit providing a control signal responsive to the data signal.

32. The optical tag of claim 26 wherein the asset data comprise at least one of asset identification data, environmental data, medical data and status data.

33. The optical tag of claim 26 wherein the tag processor generates a clock signal to trigger broadcasts of asset data.

34. The optical tag of claim 33 wherein the control signal generated by the tag processor is periodic.

35. The optical tag of claim 34 wherein the control signal generated by the tag processor is continuous.

36. The optical tag of claim 31 further comprising a trigger sensor to detect an interrogation signal in communication with the tag processor, the control signal being responsive to the detection of the interrogation signal at the trigger sensor.

37. The optical tag of claim 36 wherein the trigger sensor is one of an optical sensor, an RF sensor, an acoustic sensor and an environmental sensor.

38. The optical tag of claim 26 further comprising a switch in electrical communication with the processor, the control signal generated by the tag processor causing the optical modulator to initiate an on-demand broadcast of optical data in response to an activation of the switch.

39. The optical tag of claim 26 wherein the memory module is provided by an asset.

40. The optical tag of claim 26 further comprising an interface module in communication with the tag processor.
